(19) United States
(12) Patent Application Publication
(10) Pub. No.: US 2025/0065233 A1
(43) Pub. Date: Feb. 27, 2025

(54) SYSTEM AND METHOD FOR GENERATING A NEW COMPUTER GAME UTILIZING MACHINE LEARNING

(71) Applicant: PLAYO LTD, Tel Aviv (IL)

(72) Inventors: Ilan GRACIER, Tel Aviv (IL); Yaron LEIFENBERG, Rishon Lezion (IL)

(73) Assignee: PLAYO LTD, Tel Aviv (IL)

(21) Appl. No.: 18/809,618

(22) Filed: Aug. 20, 2024

Related U.S. Application Data
(60) Provisional application No. 63/534,610, filed on Aug. 25, 2023.

(51) Int. Cl. A63F 13/69; A63F 13/79; G06N 3/0475

(52) U.S. Cl. CPC A63F 13/69; A63F 13/79; G06N 3/0475

(57) ABSTRACT

A system and method for generating a new computer game including: training a machine learning model to generate positions and properties of second in-game units over time in the second computer game, by providing the machine learning model data descriptive of positions and properties of a plurality of first in-game units over time in a first computer game; and generating the second computer game by deriving a computerized restrictive environment and dispersing the second in-game units in the second computer game based on the generated positions and properties of the second in-game units over time in the second computer game.

### CROSS-REFERENCE TO RELATED APPLICATIONS

This application claims the benefit of U.S. Provisional Application Ser. No. 63/534,610, filed Aug. 25, 2023, which is hereby incorporated by reference in its entirety.

### FIELD OF THE INVENTION

The present invention relates generally to generating a new computer game utilizing machine learning for enhanced gameplay and game mechanics fidelity.

### BACKGROUND

Designing a computer game, also referred herein to as a video game or simply as a game, may include creating the rules of the game as well as the dispersal of game objects in the game world, is a manual task that is done by game designers as more of an art than a craft. This process is mostly arbitrary and takes weeks of prototyping and playtesting. The human game designers may define the rules and mechanics of the video game through an iterative process of prototyping and play testing. Such processes vary from one design to another and there is no automatic, computerized generative system that can produce varying game mechanics and test them.

### SUMMARY

According to embodiments of the invention, a computer-based system and method for generating a new computer game may include, using a processor: training a machine learning model to generate positions and properties of second in-game units over time in the second computer game, by providing the machine learning model data descriptive of positions and properties of a plurality of first in-game units over time in a first computer game; and generating the second computer game by deriving a computerized restrictive environment and dispersing the second in-game units in the second computer game based on the generated positions and properties of the second in-game units over time in the second computer game.

Embodiments of the invention may include providing the second computer game to a user using at least one input and output devices of a computer.

Embodiments of the invention may include generating graphics for the derived computerized restrictive environment of a requested genre using a generative network.

Embodiments of the invention may include pre-training the machine learning model to generate positions of a third in-game unit over time going from a starting point to an end point while avoiding a set of obstacles.

According to embodiments of the invention, pre-training may include: generating synthetic data comprising a plurality of routes, wherein each route comprises positions of a fourth in-game unit over time, going from one starting point of one or more starting points to one end point of one or more end points while avoiding one set of obstacles of one or more sets of obstacles; and using the synthetic data to pre-train the machine learning model.

According to embodiments of the invention, generating the synthetic data may include: providing a first route from a first starting point to a first end point and avoiding a first set of obstacles; and generating a second route that avoids the first set of obstacles by moving one of the positions in the first route to a new position and using a kinematic model to generate the second route so that the second route comprises the new position.

According to embodiments of the invention, generating the second route may include moving the one position in predetermined spatial intervals to cover one quadrant of a two-dimensional space.

Embodiments of the invention may include generating a plurality of game lines in the second computer game from a single game line in the second computer game, wherein the single game line comprises generated positions and properties of one in-game unit over time in the second computer game, by requesting the machine learning model to generate alternative positions over time going from a first position in the game line to a second position in the game line.

According to embodiments of the invention, the machine learning model may be one of a large language model (LLM) and/or a transformer type model.

According to embodiments of the invention, the positions and properties of the plurality of first in-game units over time in the first computer game may be generated from at least one of log files of the first computer game, user input recordings, or gameplay footage of the first computer game.

According to embodiments of the invention, the positions and properties of a plurality of the first in-game units over time in the first computer game may be provided to the machine learning model in the form of a graph using a game descriptive language.

According to embodiments of the invention, analyzing the positions of the plurality of the second in-game units over time in the second computer game to generate the second computerized restrictive environment for the second computer game may include: defining areas that include the positions as traversable areas, and the areas that do not include the positions as non-traversable areas.

According to embodiments of the invention, a computer-based system and method for generating a new computer game may include: pre-training machine learning model to generate a route, wherein the route comprises positions of an in-game unit over time going from a starting point to an end point while avoiding obstacles; training the machine learning model by providing game lines in a first computer game to the machine learning model to provide at least one game line of the second computer game; analyzing the least one least one game line of the second computer game to generate a computerized restrictive environment and to disperse in-game units in the second computer game; and providing the second computer game to a user using at least one input and output devices of a computer.

### BRIEF DESCRIPTION OF THE DRAWINGS

Non-limiting examples of embodiments of the disclosure are described below with reference to figures attached hereto that are listed following this paragraph. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanying drawings. Embodiments of the invention are illustrated by way of example and not limitation in the figures of the accompanying drawings, in which like reference numerals indicate corresponding, analogous or similar elements, and in which:

FIG. 1, which is a flowchart of a method for generating a new computer game, according to embodiments of the invention.

FIG. 2 depicts routes in a quadrant of a 2D plane of a computer game, according to embodiments of the invention.

FIG. 3A presents a screenshot of a computer game environment, taken at a first moment in time, helpful in demonstrating embodiments of the invention.

FIG. 3B presents a second screenshot of the computer game environment, taken at a second later moment in time, helpful in demonstrating embodiments of the invention.

FIG. 3C presents a third screenshot of the computer game environment, taken at a third later moment in time, helpful in demonstrating embodiments of the invention.

FIG. 3D presents a fourth screenshot of the computer game environment, taken at a fourth later moment in time, helpful in demonstrating embodiments of the invention.

FIG. 4A presents an initial route generated by a trained ML model, according to embodiments of the invention.

FIG. 4B presents an alternative route generated by the trained ML model, according to embodiments of the invention.

FIG. 4C presents a second alternative route generated by the trained ML model, according to embodiments of the invention.

FIG. 5 presents an example of traversable areas and non-traversable areas (e.g., obstacles), according to embodiments of the invention.

FIG. 6 presents an example of in-game units that are dispersed in traversable areas of computerized restricted environment of a new computer game, according to embodiments of the invention.

FIG. 7 shows a high-level block diagram of an exemplary computing device which may be used with embodiments of the present invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

Embodiments of the invention may provide a system and method for automatically generating blueprints for a computer game that may include rules, restrictive environments, and definitions of the game, referred to herein as game mechanics, and gameplay based on a user input of genre, game dynamics and settings.

Embodiments of the invention may provide a computerized system and method for generating new computer games with an emphasis on gameplay and game mechanics using a machine learning (ML) model. Embodiments may include pre-training techniques and utilization of spatial awareness, to navigate computerized environments while avoiding computerized obstacles. The method may initially leverage synthetic data generated through kinematic algorithms to train the ML model. Subsequently, the ML model may be further trained with graph-based data representing in-game unit movements, attributes, and gameplay mechanics. The resulting model may generate a comprehensive game environment graph, enabling the creation of computerized restrictive environments and the strategic placement of units within the computerized restrictive environments. This process may improve the technology of computer game design by ensuring the preservation of interconnectivity fidelity inherent in game design data points, based on sampled games, leading to the development of new games that maintain genre integrity and offer enriched gameplay experiences. A new game may be a newly generated game, a new level in an existing game or an updated version of a computer game modified to include new design, graphics game events, etc.

A computer game may be defined as one or more units or entities (e.g. player characters or avatars) through spacetime, guided by the player, which is provided by and effected by a computer. The journey of the one or more units or entities may be hindered by a sequence of resistances, where every game is unique in dynamic, as experienced by the player. Game data may be abstracted into units or entities, properties or attributes of the unit or entity, property change capabilities and resistances. The properties or attributes may include, among other things: location, health points. inventory, capabilities, etc. Property change capabilities may be the ability to change a position of the one or more units or entities, by how much and in what speed, the ability to change health points of an enemy entity, e.g., damage that can be inflicted on a unit or entity, etc. Game mechanics may include for example game rules, e.g., rules that governs the actions of the one or more units or entities and the reaction of the game to those actions, restrictive environments, definitions of the game, etc. Game dynamics may include the unit or entity positions or locations and interactions with other units or entities over time. The game dynamics may be used to generate restrictive environments for games as well as the dispersal of resistances that together encompass the computer game environment.

Embodiments of the invention may provide a computerized system and method for generating a new computer game. According to embodiments of the invention, generating a new computer game may include pre-training an ML model, e.g., a large language model (LLM), a transformer type model, etc., for spatial awareness and further training the pre-trained ML model with data, e.g., graphs, descriptive of in-game unit positions, movements, properties, attributes, gameplay elements, and game mechanics, over time, where each graph narrates game line, e.g., a linear story of an in-game unit within a computer game. The trained ML model may be used to generate a comprehensive game environment graph that may reflect spatial awareness by identifying traversable and non-traversable areas, based on the density and connectivity of graph nodes. The identified non-traversable areas may be used for designing the restrictive environment of the new game, ensuring that gameplay elements and game mechanics remain intact. The generated game environment graph may be used to design new games or new levels of the computer game, and to strategically distribute in-game units, such as enemies and allies, ensuring that gameplay and game mechanics maintain high fidelity to the genre of the sampled games, while preserving game dynamics and other integral gameplay features.

The game dynamics properties may include relationships between quantitative properties in a game. An example for a game dynamics property that may be preserved using embodiments of the invention may include unit-speed-to-cover ratio that is the relationship between the movement speed of an in-game unit to the average distance between structures that provide cover. Those game dynamics properties, while not provided explicitly to the ML model are included implicitly in the graphs provided to the ML model and are therefore learned by the ML model in the training process and preserved in the model results. Embodiments of the invention may improve the technology of design and generation of new computer games by automatically generating new games that preserve relationships between quantitative properties in an old (e.g., already existing) game, without having to explicitly quantify them or even to define them. For example, a game designer using embodiments of the invention may generate a new game while preserving relationships between quantitative properties of an old game, without defining these relationships, without knowing what value they should equal in order for the game to be fun and seem natural, and even without knowing what those relationships are.

Pre-training an ML model for spatial awareness may be performed by generating synthetic data, for example, using a kinematic model such as the forward and backward reaching inverse kinematics (FABRIK) algorithm. Pre-training may refer to a stage of training an ML model for spatial awareness (and not to a particular game or game genre). Generating the synthetic data may include placing or locating obstacles (e.g. data representing obstacles) in a computerized spatial environment and generating an initial route, e.g., positions of an in-game unit over time, between two points (nodes) in the computerized spatial environment, while avoiding those obstacles. When discussed herein, game elements such as mechanics, obstacles, routes, restricted areas, etc., may appear to a game player as a displayed reality, and may also be represented in a computer system generating the game as data as known in the art. Thus, an in-game unit, an obstacle, restricted area, etc., when discussed herein may refer to both the reality seen by the game player and the corresponding data used by the computer. As used herein a route may refer to positions of an in-game unit over time in a computer game, and a game line may include positions and properties of an in-game unit over time in a computer game, e.g., the linear story of an in-game unit within a computer game.

Additional routes may be generated for the synthetic data based on the initial route by moving one of the positions in the initial route and using the kinetic algorithm to generate a second route so that the second route includes the new position. This process may be repeated for different starting and end points, and for different locations of obstacles. The generated paths or routes may be used to pre-train the ML model with successful navigation paths or routes, thereby enhancing the spatial awareness of the ML model.

The synthetic data for pre-training may be generated by implementing the FABRIK algorithm, or another suitable algorithm, to iteratively adjust initial routes that avoid the obstacles in the computerized spatial environment, thus compiling a set of navigation paths (routes) for the model, enhancing its spatial awareness and gameplay fidelity. Generating the synthetic routes may involve exploring various spatial intervals within a defined two-dimensional space (e.g., the computerized spatial environment) to assess and document the viability of different navigation paths, systematically enhancing the decision-making accuracy of the pre-trained model in dynamic environments, contributing to refined gameplay mechanics.

The pretrained ML model may be further trained using training data sampled from existing computer games (also referred to as old computer games). Specifically, data, e.g., graphs, representing in-game unit movements, positions, properties, attributes, gameplay elements, and game mechanics, may be derived from gameplay data of existing games, such as log files, user input recordings, and/or gameplay footage, that may be analyzed to identify established game lines, routes, gameplay mechanics, and other interconnected elements. This may ensure that the newly generated game, generated according to embodiments of the invention, may retain essential characteristics of the genre of the original existing games, while introducing novel routes and gameplay challenges. Data extracted from the gameplay data may be provided to the ML model in a game descriptive language that may describe a video game in a structured manner.

The trained ML model may be used to synthesize or generate new game routes, e.g., positions of in-game units over time in the new computer game, and new game lines, e.g., positions and properties of in-game units over time in the new computer game, by leveraging the trained ML model to propose alternative pathways, routes or game lines within the computerized restrictive environment while considering the mechanical constraints and gameplay dynamics intrinsic to the genre of the original game, thus enhancing gameplay fidelity.

According to embodiments of the invention, the ML model may be an LLM that may be trained, as disclosed herein, to utilize spatial awareness, interpret complex spatial arrangements and devise new game mechanics and gameplay elements that may align with the old game environment. According to embodiments of the invention, the ML model may be a transformer-type model. The transformer architecture may be efficient in processing sequential data, enabling precise analysis and generation of complex game environments that adhere to genre-specific constraints, dynamics, and gameplay mechanics.

An LLM may include a computational model capable of generating general-purpose language and other natural language processing tasks. LLMs may learn, through a training process, statistical relationships between language elements from vast amounts of text. According to embodiments of the invention, routes, or positions over time, together with other gameplay data such as properties of in-game units over time, in a computer game may be represented as graphs, and the graphs may be phrased in a structured manner as linguistic statements in the game descriptive language. An LLM may be trained using those statements to provide new statements that adhere to the same rules, e.g., include graphs of a new computer game. LLMs may include artificial neural networks (NNs) that utilize the transformer architecture. A transformer is a type of NN architecture capable of learning context and relationships from sequential data such as text. A transformer may include a concatenation of many transformer blocks, each composed by an attention component followed by a NN.

Embodiments of the invention may further include generating graphics for the new computerized restrictive environment and in-game units by utilizing a generative network to produce visually consistent and genre-appropriate graphics, further enhancing the immersive quality and visual coherence of the newly generated game environment, thereby supporting enriched gameplay experiences. For example, a user may specify the required genre for the generated computer game, and the required genre may be provided to the generative network that may generate graphics for the new computerized restrictive environment that fits the genre.

Embodiments of the invention may improve the technology of computer games and computer games creation by enabling automatic computer game generation. Using the trained ML model disclosed herein may shorten the time required to develop a game design from weeks to seconds, and may enable everyone to generate a reasonably designed game without any training or experience. Games generated by the trained ML model disclosed herein may maintain genre integrity and offer enriched gameplay experiences while preserving interconnectivity fidelity of the sampled games.

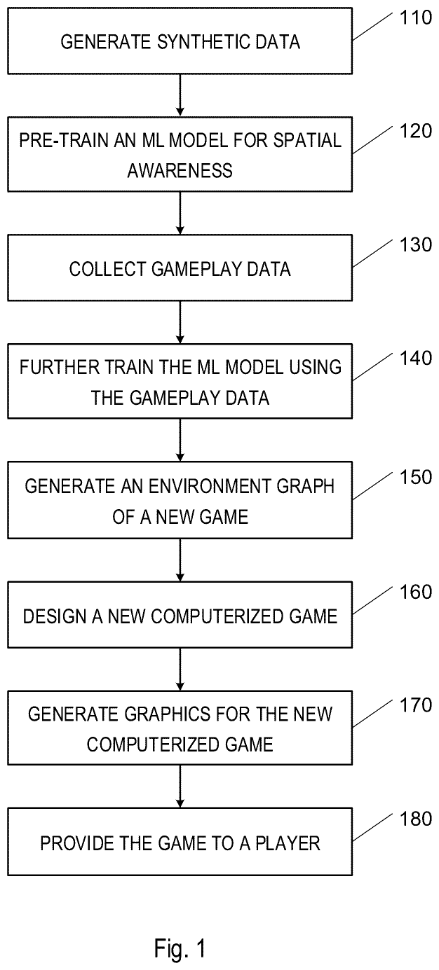

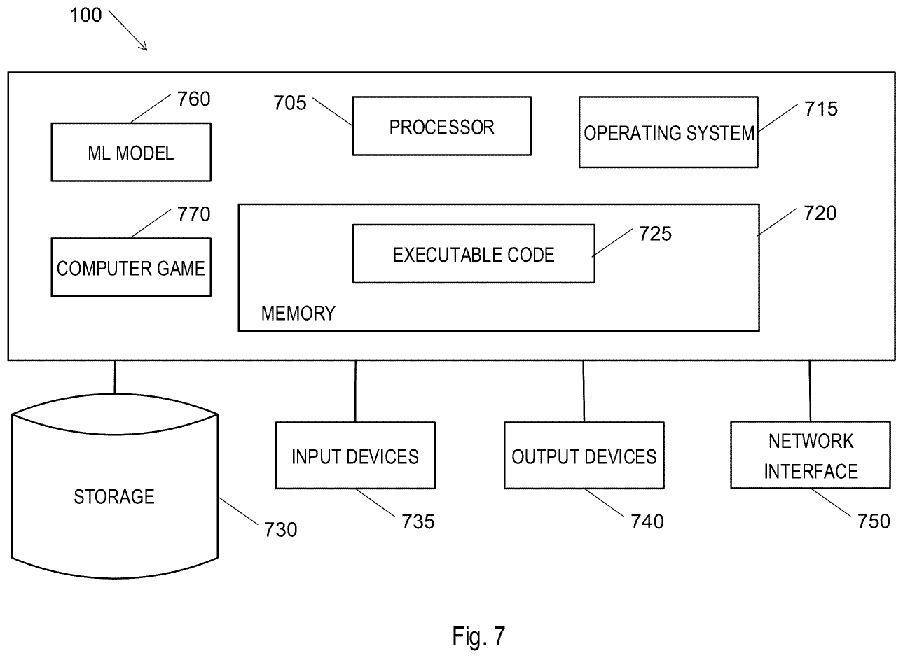

Reference is now made to FIG. 1, which is a flowchart of a method for generating a new computer game, according to embodiments of the invention. While in some embodiments the operations of FIG. 1 are carried out using systems as shown in FIG. 7, in other embodiments other systems and equipment can be used.

In operation 110, a processor (e.g., processor 705 depicted in FIG. 7, when executing executable code 725) may generate synthetic data for pre-training an ML model (e.g., ML model 760 depicted in FIG. 7) for spatial awareness. The synthetic data may include a plurality of routes, where each of the routes may include positions of an in-game unit (or pseudo in-game unit) over time extending between two points in the game space, e.g., going from a starting point to an end point in a two two-dimensional (2D) plane of the game or in a three-dimensional (3D) space of the game, while avoiding obstacles, e.g., a set of obstacles. The routes may be generated in any applicable manner, e.g., manually, by applying a bot to generate the routes, etc. In some embodiments, routes may be generated using a kinematic model such as the FABRIK model.

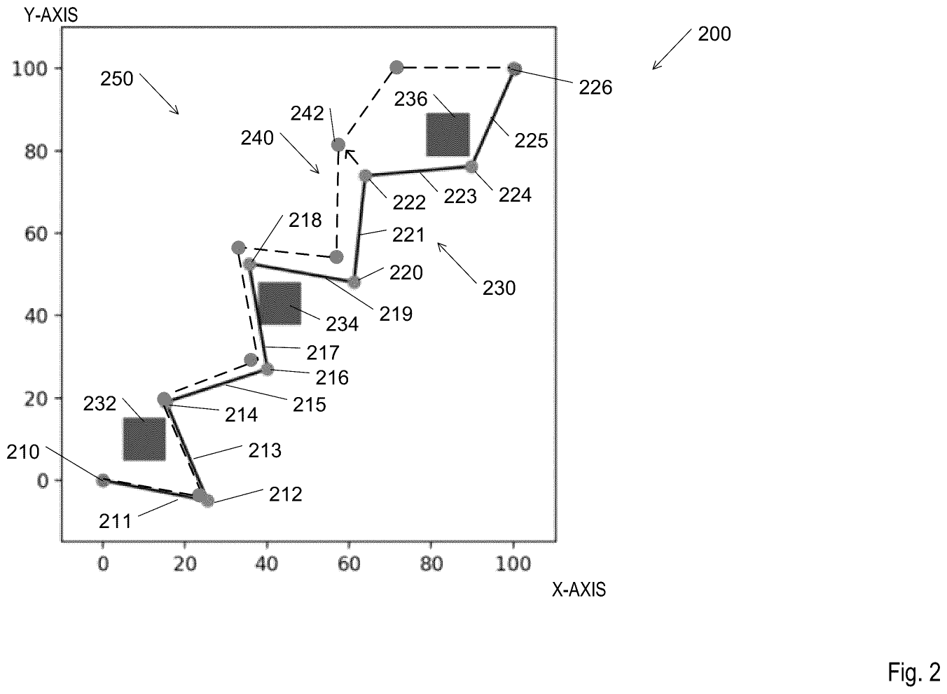

Reference is now made to FIG. 2 which depicts routes 230 and 240 in a quadrant of 2D plane 200 of a computer game, according to embodiments of the invention. In the example of FIG. 2, plane 200 includes a set of obstacles including three obstacles 232, 234 and 236 (the set of obstacles may include other shapes and number of obstacles). Obstacles 232, 234 and 236 may define areas in 2D plane 200 that routes 230 and 240 should avoid. Obstacles 232, 234 and 236 may be introduced at random or predetermined coordinates and may serve as spatial constraints. Thus, 2D-plane 200 together with obstacles 232, 234 and 236 may define a computerized restrictive environment 250, e.g., an environment that includes non-traversable areas, e.g., areas that routes 230 and 240 should avoid, e.g., obstacles 232, 234 and 236, and traversable areas, e.g., areas in which routes 230 and 240 are allowed to pass, e.g., 2D-plane 200 except for obstacles 232, 234 and 236. Each route 230 may be described or represented as a graph that includes nodes and edges, where the edges are links connecting the nodes. For example, route 230 may include starting node 110, end node 126, and intermediate nodes 212, 214, 216, 218, 220, 222 and 224, and edges or links 211, 213, 215, 217, 219, 221 and 223, connecting between them.

Route 230 may describe positions or locations of an in-game unit, or a pseudo in-game unit, over time, in 2D-plane 200. For example, in time t0, the pseudo in-game unit may be located or positioned at point [0,0] in 2D-plane 200, which is the starting point or starting node 210 of route 230. In time t1>t0, the pseudo in-game unit may be located at point [25,-11] in 2D-plane 200, which is the position of node 212. It is noted that in the time between to and t1, the pseudo in-game unit may go or traverse from starting node 210 to node 212 through link 211. Similarly, at time t2>t1 the pseudo in-game unit may be located at point [20,-20] in 2D-plane 200, which is the position of node 214, and so on. As can be seen, the pseudo in-game unit has traversed from starting node 210 to node 214, through link 211, node 212 and link 213, while avoiding obstacle 232.

In some embodiments, kinematic models, such as the FABRIK algorithm may be used for generating a plurality of routes, where each route includes positions of the pseudo in-game unit over time, starting from an initial route, e.g., from route 230. Initial route 230 may be generated manually, by computer software or in any other applicable form. For example, generating a plurality of routes for the synthetic data starting from route 230 may include moving at least one of the nodes (representing a position over time) of initial route 230, e.g., node 222, to a new position or location 242, and using the kinematic model, e.g., the FABRIK model, to generate second route 240 that includes the new node location or position 242. This process may be repeated for generating as many routes as needed, each time moving one or more nodes of an already existing route to a new location, or by changing computerized restrictive environment 250, e.g., by changing the number, shape, size and/or location of obstacles 232, 234 and 236 in the set of obstacles. In some embodiments, node 222 may be moved in predetermined spatial intervals (e.g., at a certain direction and a certain distance relative to the original location of node 222 in route 230, or at a certain angel relatively to link 223) to cover one quadrant of a 2D space 200. Limiting the generation of routes to a single quadrant of a 2D space 200, and limiting the spatial intervals by which nodes 210, 212, 214, 216, 218, 220, 222, 224 and 226 may be moved is not mandatory, but has been proven to provide sufficient variety of routes 230 and 240 to adequately pretrain ML model 760, while reducing the computational power required for generating the routes and for pretraining ML model 760 compared to generating routes all over 2D plane 200 without any limitation on the spatial intervals. The size of the spatial intervals may depend on the required accuracy.

Using a kinematic model, e.g., the FABRIK model, for generating routes, while not mandatory, has been shown to generate new routes that adhere to spatial constraints and maintain graph fidelity, e.g., by avoiding obstacles 232, 234 and 236. Other methods may be used for generating routes of the synthetic data, and/or other kinematic models may be used. For example, while the length and number of links 211, 213, 215, 217, 219, 221, 223 and 225 are kept constant across routes 230 and 240 when using the FABRIK algorithm, this is not mandatory for this application and generating new routes may include changing the length and number of links 211, 213, 215, 217, 219, 221, 223 and 225 as well.

According to embodiments of the invention, routes 230 and 240 may be provided to ML model 760 using a spatial descriptive language that may describe routes 230 and 240 and obstacles 232, 234 and 236 in a structured manner. For example, a statement describing routes 230 and 240 may include the size, shape and locations of obstacles 232, 234 and 236, and a representation of route 230 as a graph having nodes 210, 212, 214, 216, 218, 220, 222, 224 and 226. In some embodiments, the size and shape of obstacles 232, 234 and 236 may be constant across all routes 230 and 240, and thus only the locations of obstacles 232, 234 and 236 may be included in the statement describing routes 230 and 240. In some embodiments, the lengths of all links 211, 213, 215, 217, 219, 221, 223 and 225 of all routes 230 and 240 may be equal, in which case the statements may include angels instead of node locations, e.g., the angle that a link 211, 213, 215, 217, 219, 221, 223 and 225 creates relatively to the previous link 211, 213, 215, 217, 219, 221, 223 and 225, or the angle that a link 211, 213, 215, 217, 219, 221, 223 and 225 creates relatively to the x-axis, or the angle that a link 211, 213, 215, 217, 219, 221, 223 and 225 creates relatively to the y-axis, etc. Locations of obstacles 232, 234 and 236 and of nodes 210, 212, 214, 216, 218, 220, 222, 224 and 226 (if applicable) may be provided as Cartesian coordinates relative to the x-axis and y-axis of the plane. The statement describing routes 230 and 240 may include other data such as the genre of the computer game, or any other applicable data. A statement for describing route 230 may be, for example:

<START> <DELTA_RATIO_100_100> <GENRE GENERAL>
<OBSTACLE_AT_10_10> <OBSTACLE_AT_43_43> <OBSTACLE_AT_84_84>
<HYPO_PATH_RATIO_150> −11 113 18 100 −10 84 5 66 <END>

Where DELTA_RATIO_100_100 provides the location of end node 126, e.g., coordinates (100,100), in this example the location of starting point or starting node 210 is always at coordinates (0,0) and therefore this information in not included in the statment, <GENRE_GENERAL> implies that the genre of the computer game is general, <OBSTACLE_AT_10_10> implies that the first obstacle 232 is located at coordinates (10,10), similarly, <OBSTACLE_AT_43_43> and <OBSTACLE_AT_84_84> provide the locations of the second and third obstacles 234 and 236, and −11 113 18 100-10 84 5 66 provides the angle that each of links 211, 213, 215, 217, 219, 221, 223 and 225, respectively, creates relatively to the previous link, or with respect to the x-axis for the first link 211. Other formats for structurally describing routes 230 and 240 may be used.

Returning to FIG. 1, in operation 120, the processor may pre-train an ML model 760, e.g., ML model 760, for spatial awareness, using routes 230 and 240 generated in operation 110, e.g., statements describing routes 230 and 240 of the synthetic data may be provided to ML model 760 at the pre-training stage 120 as training data. The processor may pre-train an ML model 760 to generate positions of an in-game unit over time going from a starting point to an end point while avoiding a set of obstacles using the synthetic data generated in operation 110. ML model 760 may include an LLM, a transformer, or any other suitable ML model. For example, ML model 760 may include a scalable LLM architecture that can be tailored to different levels of complexity and efficiency, such as a medium-sized transformer-based model. ML model 760 may be trained to understand the spatial descriptive language used for describing routes 230 and 240 and obstacles 232, 234 and 236 and to generate new routes that obey the same spatial rules as routes 230 and 240 of the training data. Thus, after pre-training, ML model 760 may be able to generate new routes that may navigate around obstacles effectively. The generated routes may adhere to trigonometric and kinematic constraints, creatively navigating obstacles while maintaining coherence. Routes 230 and 240 may be provided to ML model 760 in the form of graphs of locations over time that describe routes 230 and 240 going between starting node 210 and end node 226, while avoiding obstacles 332, 334 and 226. ML model 760 may be pre-trained to be able to create new routes or graphs of locations over time that provide a route or path between two points or nodes in space while avoiding obstacles. Training metrics may include, for example:
Training loss, which is a measure of how well ML model 760 is performing on the training data, may assess learning efficiency on the synthetic data generated in operation 110. The training loss may be calculated during training and used to update the parameters of ML model 760, e.g., using gradient descent, to minimize this loss.
Evaluation or test loss that is measured to evaluate performance across epochs. Evaluation or test loss may be measured in a similar manner to the training only on different data, to assess how well ML model 760 may perform in real-world scenarios.
Epochs may be optimized based on dataset size and model complexity.

The understanding of spatial relationships of ML model 760 may result in generating coherent routes and interactions, enhancing the realism and immersion of game environments. Pre-training ML model 760 for spatial awareness in operation 120 may enhance the overall system by providing a foundational understanding of spatial relationships and obstacle navigation, enabling the generation of engaging game environments that align with gameplay mechanics and player interactions. Pre-training ML model 760 for understanding spatial relationships may enable ML model 760 to generate coherent routes and interactions, that may enhance, at later stages, the realism and immersion of game environments. The ability of pre-trained ML model 760 to navigate around obstacles may improve the adaptability pre-trained ML model 760 to various game scenarios, enhancing the challenge and engagement for players.

It is noted that in some embodiments, operations 110 and 120 are performed and contribute to the overall system by providing a foundational understanding of spatial relationships and obstacle navigation, enabling the generation of engaging game environments. However, in some embodiments these operations are not mandatory, and the system may train ML model 170 using gameplay data, starting from operation 130.

In operation 130, the processor may collect gameplay data, including for example, in-game unit movements, positions, properties, attributes, gameplay elements, game mechanics, etc. Gameplay data may be extracted from, for example, log files, user input recordings, and/or gameplay footage of existing games played by human players or by bots. The bots may be trained to play a specific game using, for example, reinforced learning, based on initial recordings and/or log files of the same games played by human players. The trained bots may play the computer game, providing more log files, user input recordings, and/or gameplay footage from which gameplay data may be extracted. Gameplay footage, also referred to as gameplay videos, may include video (e.g., visual or audiovisual) recordings of one or more players playing the game. Log files may include text files that record history of in-game events, user interactions, and errors over time. User input recordings may include user actions that are collected or recorded through input devices of a computer (e.g., input devices 730) while playing games. These recordings may capture over 90% of game influential events. Gameplay data may be categorized and tagged according to game genre, descriptions, settings, critics and player rankings and ratings, as well as sales and play numbers.

The processor may analyze the collected gameplay data (e.g., of a single game or a single game genre) to identify established routes, gameplay mechanics, and other interconnected elements. The processor may represent the gameplay data of a single unit (in-game unit) in the game as a game line that include positions and properties of the in-game unit over time. The game line may be provided in the form of a graph, where the graph may provide a linear sequence of events of the in-game unit over time within a game. The processor may formulate the game line or graph in a game descriptive language, e.g., a language that is similar to or an elaboration of the spatial descriptive language, that may describe the linear sequence of events, e.g., positions over time (routes), and properties of over time, e.g., actions and attribute changes, of the in-game unit in the computer game, in a structured manner.

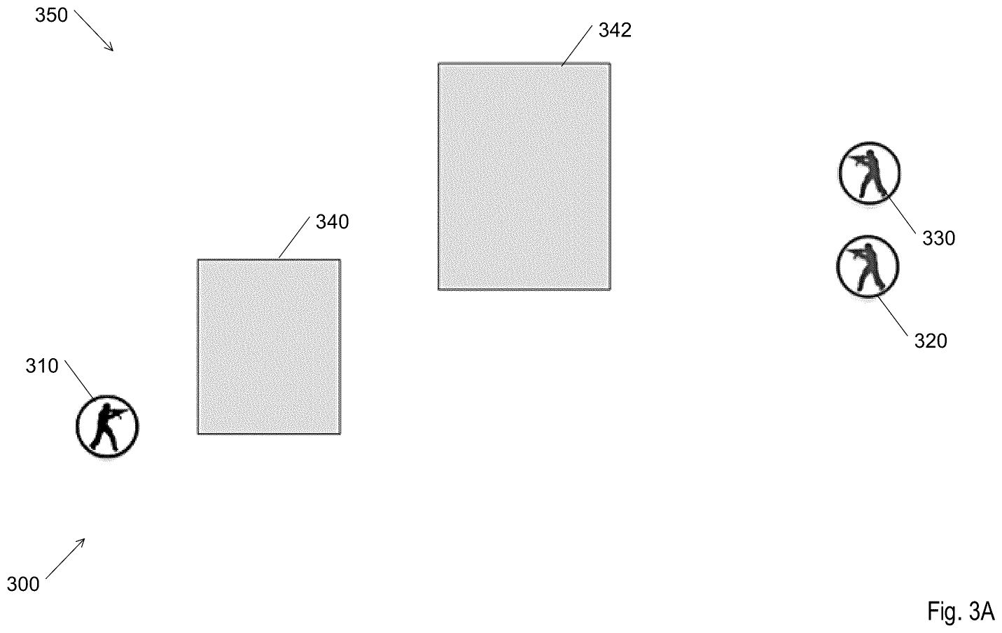

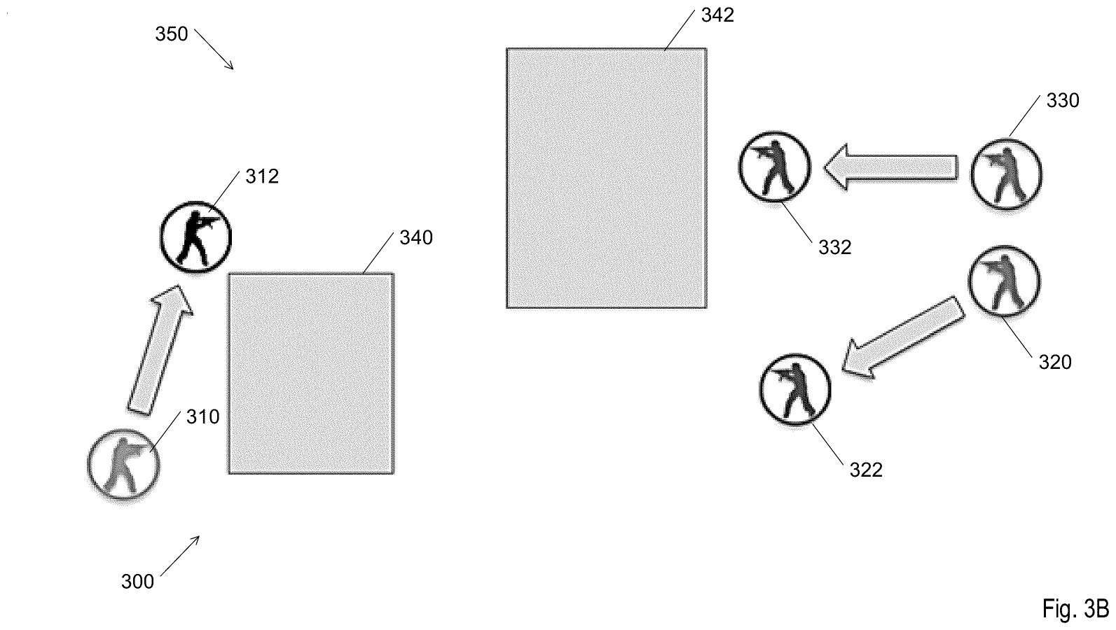

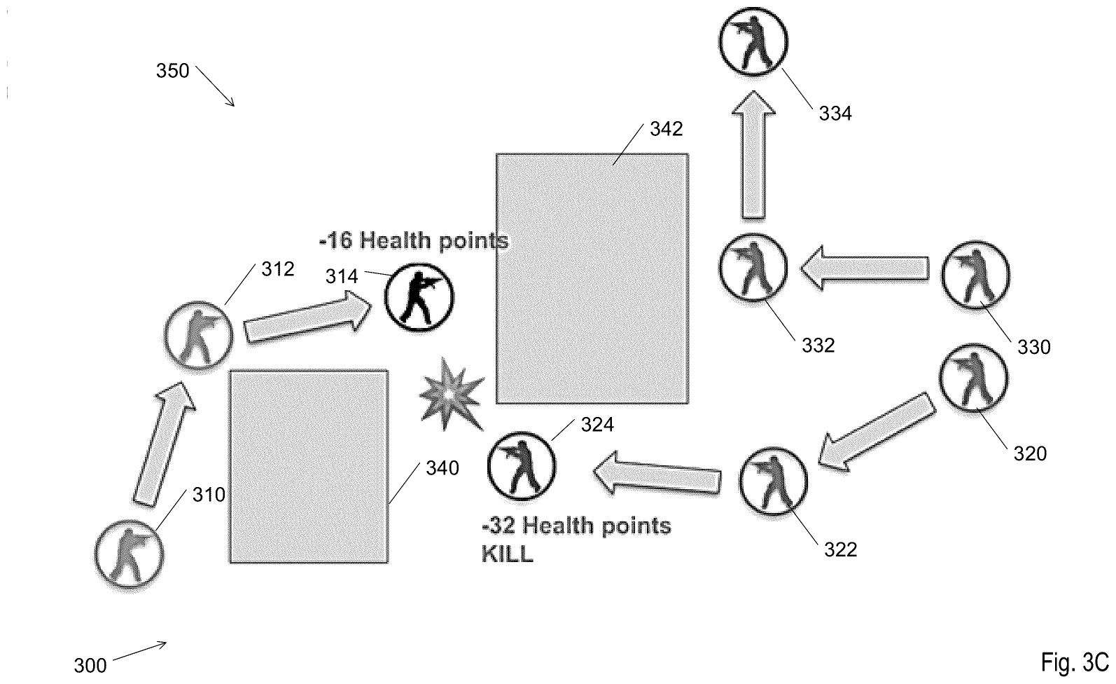

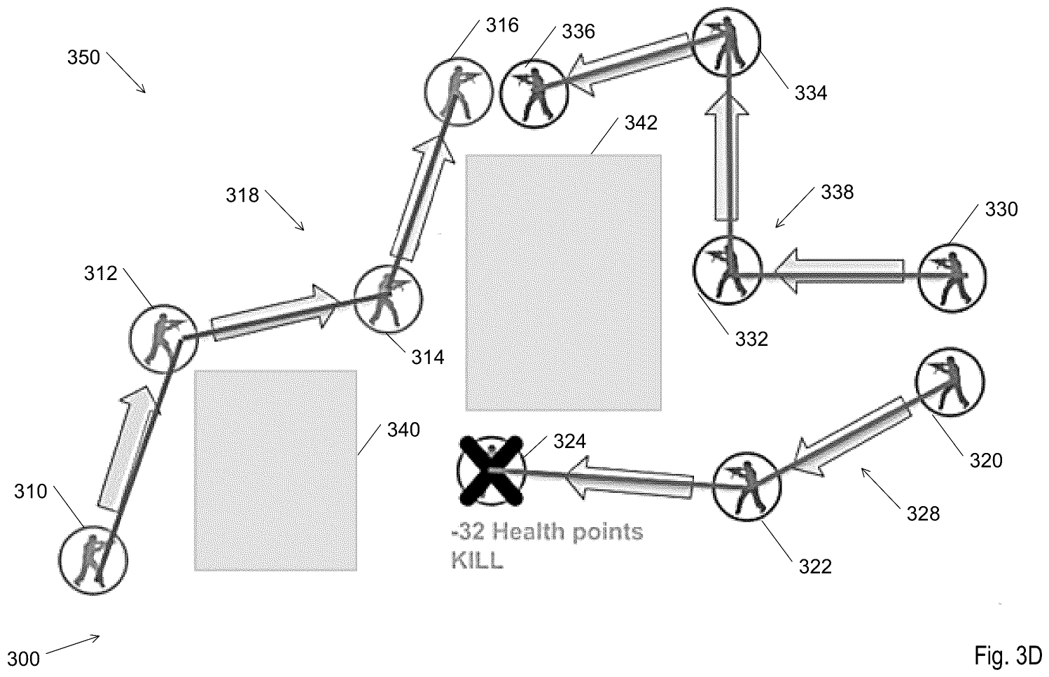

Reference is now made to FIGS. 3A-D, which presents screenshots of a shooting computer game in four points in time, helpful in demonstrating embodiments of the invention. FIG. 3A, presents a screenshot of a computer game environment 300, taken at a first moment in time, t0. In this initial stage the computer game includes three in-game units 310, 320 and 330, and two obstacles 340 and 342. Each of in-game units 310, 320 and 330 may represent a human player or an in-game figure, and may be associated with certain properties, e.g., attributes or game assets that may change over time as the game progresses. Obstacles 340 and 342 may define non-traversable areas and the rest of environment 300 as the traversable area 350. FIG. 3B, presents a second screenshot of the same computer game environment 300, at a second later moment in time, t1>t0. As can be seen, in-game unit 310 has moved to a new location or position 312, in-game unit 320 has moved to a new location or position 322, and in-game unit 330 has moved to a new location or position 332. In FIG. 3C, which presents a third screenshot of the same computer game environment 300, at a third moment in time, t2>t1, in-game unit 310 has moved to a new location or position 314, in-game unit 320 has moved to a new location or position 324, and in-game unit 330 has moved to a new location or position 334. Additionally, a game battle, defined by the game mechanics of the shooting game, has occurred between in-game unit 310 and in-game unit 320, in which some properties or attributes of in-game unit 310 and in-game unit 320 have changed, again according to the game mechanics. In this example, in-game unit 310 has lost 16 health points and in-game unit 320 has lost 32 health points. In FIG. 3D, which presents a fourth screenshot of the same computer game environment 300, at a fourth moment in time, t3>t2, in-game unit 310 has moved to a new location or position 316, and in-game unit 330 has moved to a new location or position 336. In-game unit 320, however, has been removed from the game, since according to the game mechanics, losing 32 health points results in losing a “life” in the game. As can be seen in FIG. 3D, the routes 318, 328 and 338 of in-game units 310, 320 and 330, respectively, adhere to the game restrictive environment, as they only traverse the traversable areas 350. Routes 318, 328 and 338 may be represented as graphs, similarly to routes 230 and 240 of the pre-training synthetic data. The graphs of game lines including routes 318, 328 and 338 may be described as statements in the game descriptive language that may include other game events such as the battle between in-game unit 310 and in-game unit 320 and the changes properties over time, e.g., in this case health points, for each of in-game units 310 and 320 that occurred as a result of that battle.

Training data for further training the pretrained ML model, e.g., graphs of game lines including routes 318, 328 and 338 representing in-game unit positions and properties over time, may be derived or generated from gameplay data of existing games, such as log files, user input recordings, and/or gameplay footage, that may be analyzed to identify established routes, gameplay mechanics, and other interconnected elements. This may ensure the newly generated game retains essential characteristics of its genre while introducing novel routes and gameplay challenges. Data extracted from the gameplay data may be provided to ML model 760 in a game descriptive language that may describe a video game in a structured manner that can describe different game genres.

In operation 140, the processor may train ML model 760 using the gameplay data, e.g., the statements provided in the game descriptive language generated in operation 130. Training or further training ML model 760 using real game data may fine tune ML model 760 to produce games similar to the game used for generating the training data in operation 130. Specifically, ML model 760 may be trained to generate positions and properties of in-game units over time in the new computer game, by providing ML model 760 data descriptive of positions and properties of a plurality of first in-game units over time in a first computer game. ML model 760 may be trained to produce game lines (e.g., provided as graphs) that are similar to routes 318, 328 and 338 and associated properties of in-game units to provide game events that are similar to those of the game used in operation 130. The positions and properties of a plurality of in-game units over time in the old computer game may be provided to ML model 760 in the form of a graph using the game descriptive language.

In operation 150, the processor may generate, using trained ML model 760, new game lines including positions and properties of in-game units over time in the new computer game 770. The positions and properties of an in-game unit over time in the new computer 770 game may be generated in the form of a graph representing routes (positions over time) and game events (e.g., properties over time) of a new computer game 770. Since ML model 760 has been trained on a specific game or a specific game genre, it is expected that the generated graphs would adhere to the game mechanics and characteristics of that specific game or genre, and thus may be used to generate a new computer game 770 that would provide a similar user experience. The generated game lines may be used to generate a comprehensive game environment graph that may reflect spatial awareness by identifying traversable and non-traversable areas, based on the routes in the generated game lines, e.g., based on density and connectivity of graph nodes. For example, areas that include routes, e.g., graph nodes and links, may be identified as traversable areas, and areas that do not include routes, e.g., do not include graph nodes and links, may be identified as non-traversable areas. Trained ML model 760 may be used to synthesize or generate new game routes by leveraging trained ML model 760 to propose alternative pathways or routes within the restrictive environment while considering the mechanical constraints and gameplay dynamics intrinsic to the game's genre, thus enhancing gameplay fidelity.

In some embodiments, the processor may, in operation 150, generate a plurality of routes or game lines in the new computer game 770 that may define traversable and non-traversable areas. In some embodiments, the processor may use reverse traversal to expend each generated graph of a game line into a tree. Using the reverse traversal algorithm, the processor may generate a plurality of routes or game lines in the new computer game 770 from one generated route or game line of the new computer game 770 by repeatedly requesting ML model 760 to generate an alternative route or game line going from a first node (e.g., position in time) in the generated route or game line to a second node (e.g., position in time) in the same route or game line.

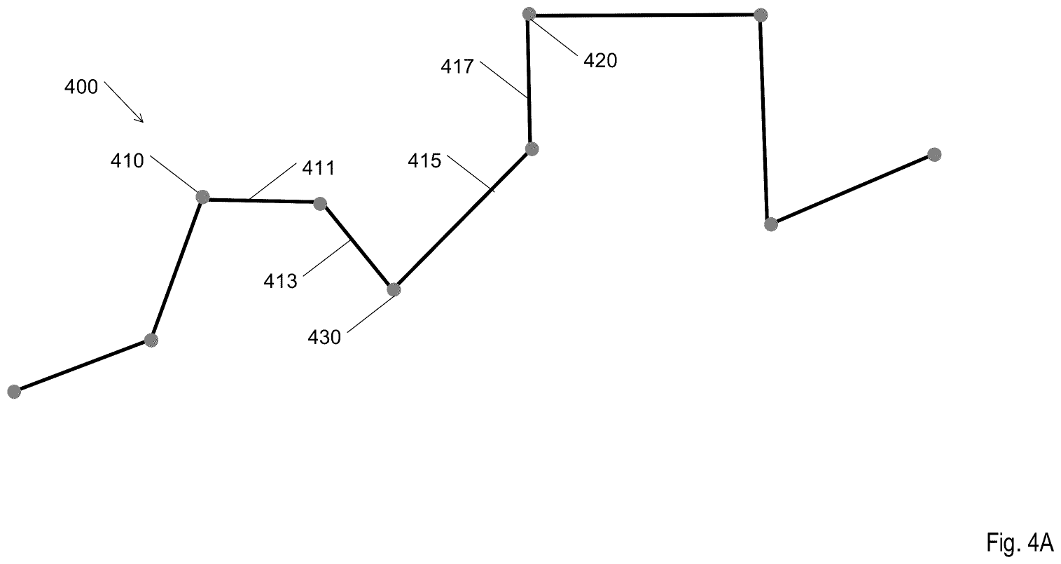

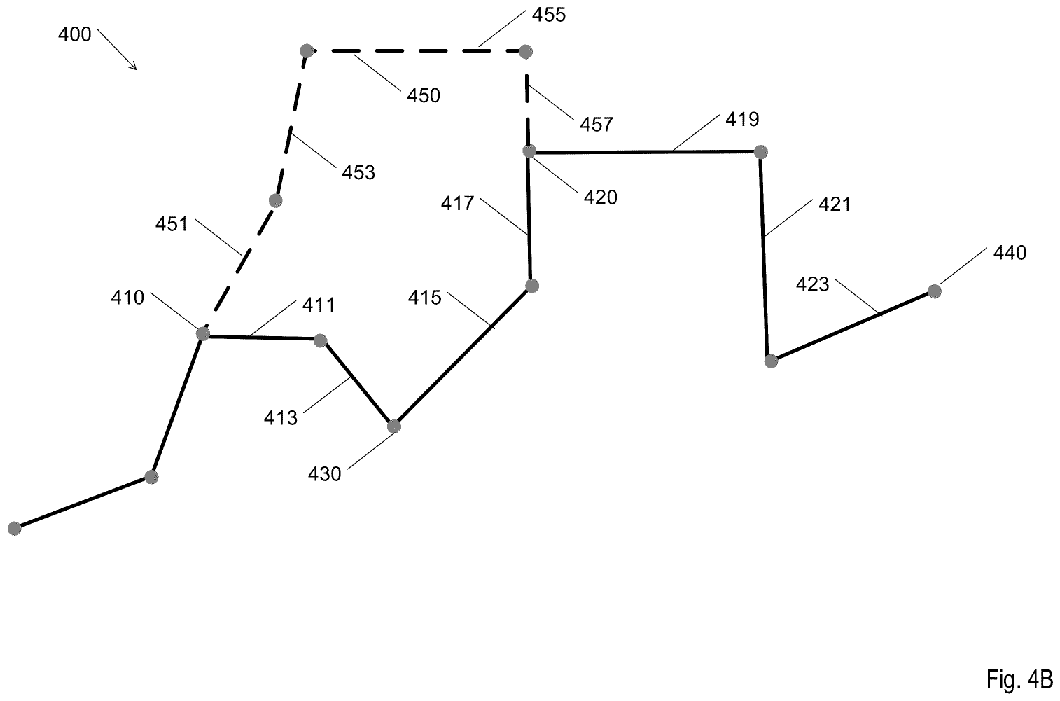

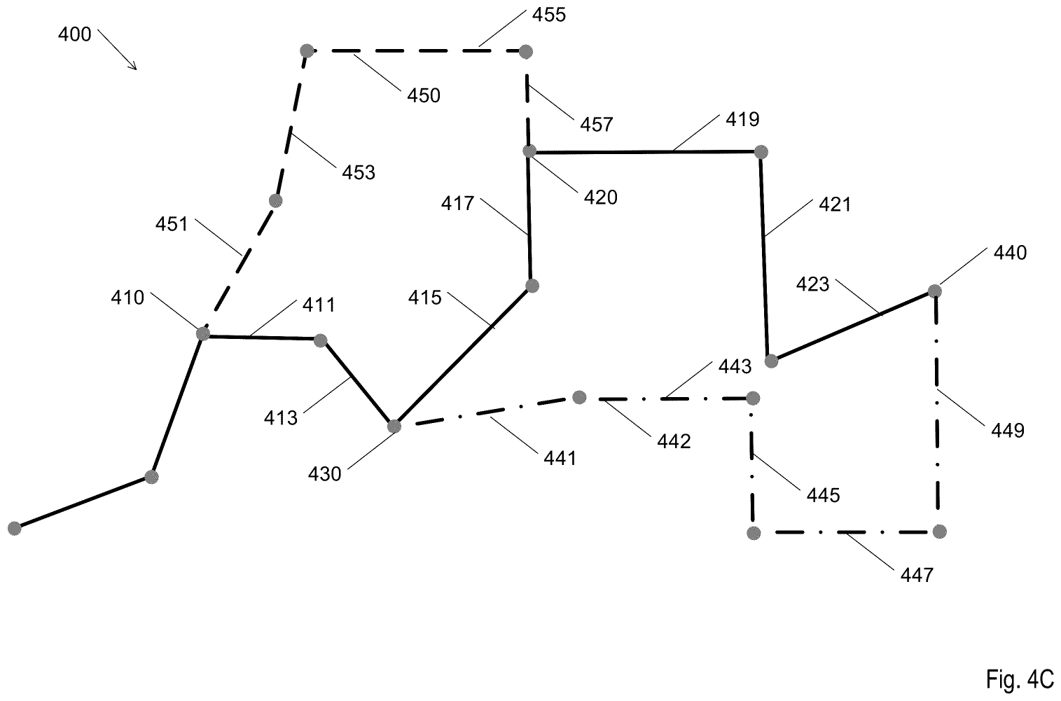

Reference is now made to FIGS. 4A-C which demonstrate expanding a single route or game line 400 generated by ML model 760 into a tree 450, according to embodiments of the invention. In FIGS. 4A-C nodes are represented by dots and links by lines where each node include a position and properties of an in-game unit in a point in time. Initial route or game line 400, as generated by trained ML model 760 is presented in FIG. 4A. According to the reverse traversal algorithm, after obtaining route or game line 400, the processor may request ML model 760 to generate an alternative route or game line to links 411, 413, 415 and 417, extending from node 410 to node 420. The generated alternative route or game line 450, presented in FIG. 4B, may include links 451, 453, 455 and 457. Similarly, the processor may request ML model 760 to generate an alternative route or game line 442 to links 415, 417, 419, 421 and 423, extending from node 430 to node 440. The generated alternative route or game line 442 presented in FIG. 4C, may include links 451, 453, 455, 457 and 459. This process may be repeated as many times as required to generate a variety of routes or game lines from nodes in initial route or game line 400 (or in alternative routes or game lines 442 and 450) to other nodes in initial route or game line 400 (or in alternative routes or game lines 442 and 450).

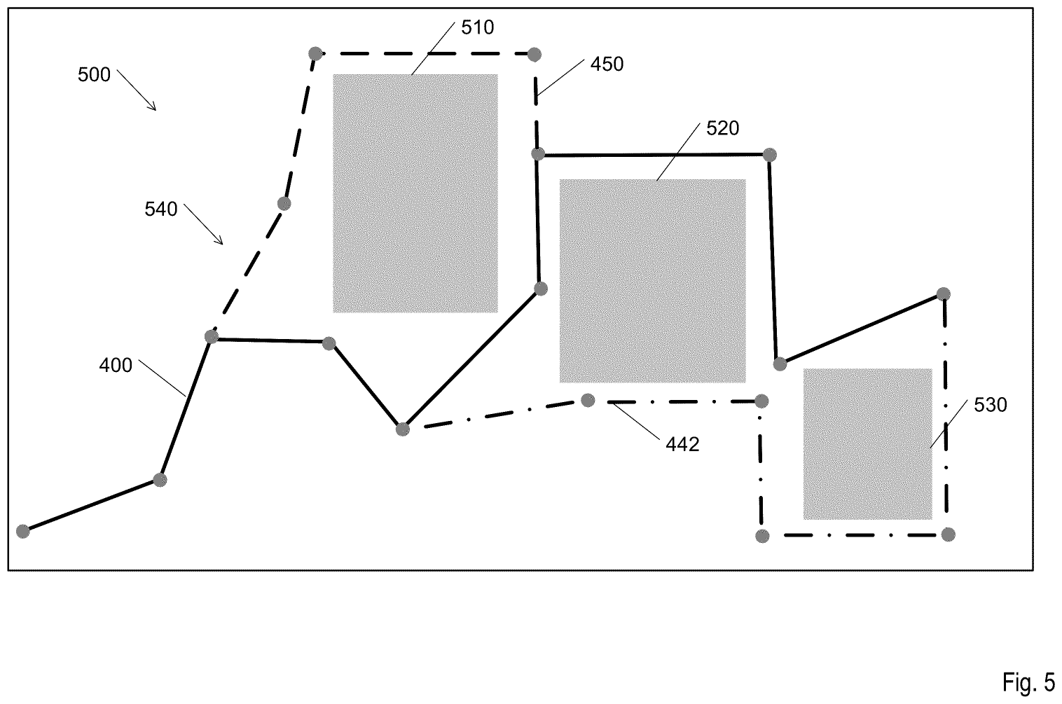

In operation 160, the processor may use routes or game lines 400, 442 and 450 generated in operation 150 to design a new computerized game. The processor may generate the new computer game 770 by deriving a computerized restrictive environment and dispersing in-game units in the new computer game 770 based on the generated game lines e.g., based on positions and properties of the in-game units over time in the new computer game 770. For example, the processor may analyze the positions of in-game units over time routes or game lines 400, 442 and 450 in the new computer game 770 to define, generate or derive the new computerized restrictive environment 500 for the new computer game 770. Specifically, the processor may define areas that include positions in routes or game lines 400, 442 and 450 as traversable areas, and the areas that do not include positions in routes or game lines 400, 442 and 450 as non-traversable areas (obstacles). The positions in routes or game lines 400, 442 and 450 may include the position of nodes as well as links in routes or game lines 400, 442 and 450. An example of traversable areas 540 and non-traversable areas (obstacles) 510, 520 and 530 of a computerized restricted environment 500 of a new computer game 770 is presented in FIG. 5. Any applicable algorithm may be used to define traversable areas 540 and non-traversable areas (obstacles) 510, 520 and 530 from positions in routes or game lines 400, 442 and 450. Computerized restricted environment 500 including traversable areas 540 and non-traversable areas (obstacles) 510, 520 and 530 may be translated into 3D structures using any applicable method.

The identified non-traversable areas 510, 520 and 530 may be used for deriving or designing the restrictive environment 500 of the new game, ensuring that gameplay elements and game mechanics remain intact.

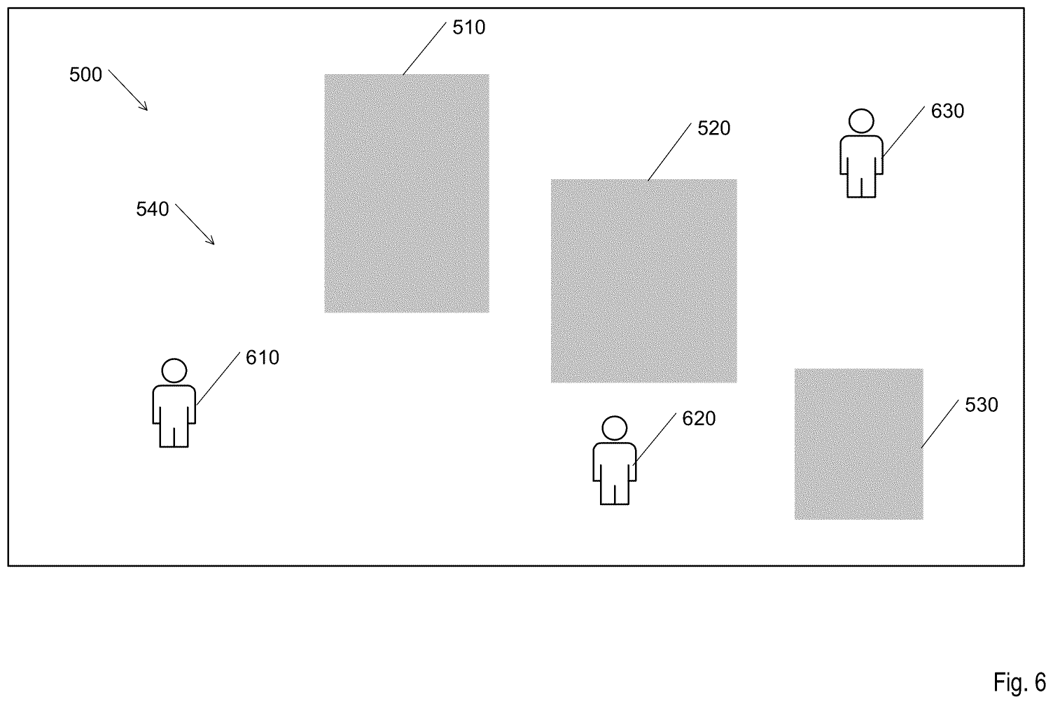

The generated game lines may be used to disperse in-game units in new computer game 770, e.g., to distribute or place in-game units in traversable areas 540. Since the generated game lines may include the locations and properties of in-game units over time in new computer game 770, this information may be used by the processor to place, disperse or distribute in-game units in traversable areas 540. For example, the processor may disperse in-game units of players according to the initial locations of in-game units in the game lines, and place, disperse or distribute and guide figures (e.g., in-game units that are guided by the game mechanics or game engine and not by a player) in the new game over time, according to the generated game lines. An example of in-game units 610, 620 and 630 that are dispersed in traversable areas 540 of computerized restricted environment 500 of a new computer game 770, according to embodiments of the invention, is presented in FIG. 6. In this example, in-game units 610 and 620 are operated by players, while in-game unit 630 is a game figure, e.g., an in-game unit that is guided by the game mechanics or game engine and not by a player.

The generated game environment graph may be used to design new levels of the video game, and to strategically distribute in-game units, such as enemies and allies, ensuring that gameplay and game mechanics maintain high fidelity to the genre of the sampled games, while preserving critical dynamics such as unit-speed-to-cover ratios and other integral gameplay features

In operation 170, the processor may generate graphics for the new computerized game. The processor may generate graphics for the derived computerized restrictive environment 500 of a requested genre using a generative network. For example, the processor may utilize a generative network, e.g., a generative adversarial network (GAN) or other types of generative networks, to produce or generate graphics for decorating computerized restricted environment 500 and in-game units of new computer game 770. The generative network may generate visually consistent and genre-appropriate graphics, further enhancing the immersive quality and visual coherence of the newly generated game environment, thereby supporting enriched gameplay experiences. The generative network may be trained using graphic input from the Internet, or from relevant graphics libraries, For example, a user may specify the required genre for generated computer game 770, and the required genre may be provided to the generative network that may search the internet and/or graphics libraries for graphic input related to the required genre and generate graphics for the new computerized restrictive environment that fits the genre, e.g., after training on the graphic input. In operation 180, the processor may provide the game to a player using one or more of input devices 735 and output devices 740 depicted in FIG. 7, e.g., on a display or a screen.

FIG. 7 shows a high-level block diagram of an exemplary computing device which may be used with embodiments of the present invention. Computing device 700 may include a controller or processor 705 that may be or include, for example, one or more central processing unit processor(s) (CPU), one or more graphics processing unit(s) (GPU), one or more data processing unit(s) (DPU) a chip or any suitable computing or computational device, an operating system 715, a memory 720, a storage 730, input devices 735 and output devices 740.

Operating system 715 may be or may include any code segment designed and/or configured to perform tasks involving coordination, scheduling, supervising, controlling or otherwise managing operation of computing device 700, for example, scheduling execution of programs. Memory 720 may be or may include, for example, a Random Access Memory (RAM), a read only memory (ROM), a Dynamic RAM (DRAM), a volatile memory, a non-volatile memory, a cache memory, or other suitable memory units or storage units. Memory 720 may be or may include a plurality of possibly different memory units. Memory 720 may store for example, instructions to carry out a method (e.g. code 725), and/or data such as model weights, etc.

Executable code 725 may be any executable code, e.g., an application, a program, a process, task or script. Executable code 725 may be executed by processor 705 possibly under control of operating system 715. For example, executable code 725 may when executed carry out methods according to embodiments of the present invention. For the various modules and functions described herein, one or more computing devices 700 or components of computing device 700 may be used. One or more processor(s) 705 may be configured to carry out embodiments of the present invention by for example executing software or code. For example, one or more processor(s) 705 may be configured to train an ML model 760 to generate a new computer game 770, as disclosed herein. One or more processor(s) 705 may be located at a remote site, e.g., on a cloud for implementing cloud computing.

Storage 730 may be or may include, for example, a hard disk drive, a floppy disk drive, a Compact Disk (CD) drive, or other suitable removable and/or fixed storage unit. Data such as instructions, code, telemetry data, etc. may be stored in a storage 730 and may be loaded from storage 730 into a memory 720 where it may be processed by processor 705. Some of the components shown in FIG. 7 may be omitted. Some or all of storage 730 be located at a remote site, e.g., on a cloud for implementing cloud storage.

Input devices 735 may be or may include for example a mouse, a keyboard, a touch screen or pad or any suitable input device. Any suitable number of input devices may be operatively connected to computing device 700 as shown by block 735. Input devices 735 may be used to obtain commands from a player while playing a computer game. Output devices 740 may include displays, screens, speakers and/or any other suitable output devices. Any suitable number of output devices may be operatively connected to computing device 700 as shown by block 740. Output devices 740 may be used to provide a computer game to a user, e.g., the generated graphics of the computer game may be displayed on a display or a screen. Any applicable input/output (I/O) devices may be connected to computing device 700, for example, a modem, printer or facsimile machine, a universal serial bus (USB) device or external hard drive may be included in input devices 735 or output devices 740. Network interface 750 may enable device 700 to communicate with one or more other computers or networks. For example, network interface 750 may include a wired or wireless NIC.

Embodiments of the invention may include one or more article(s) (e.g. memory 720 or storage 730) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

One skilled in the art will realize the invention may be embodied in other specific forms using other details without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein. In some cases well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” can include, for example, “multiple” or “two or more”. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method for generating a second computer game, the method comprising, using a processor:
training a machine learning model to generate positions and properties of second in-game units over time in the second computer game, by providing the machine learning model data descriptive of positions and properties of a plurality of first in-game units over time in a first computer game; and
generating the second computer game by deriving a computerized restrictive environment and dispersing the second in-game units in the second computer game based on the generated positions and properties of the second in-game units over time in the second computer game.

2. The method of claim 1, comprising providing the second computer game to a user using at least one input and output devices of a computer.

3. The method of claim 1, comprising generating graphics for the derived computerized restrictive environment of a requested genre using a generative network.

4. The method of claim 1, comprising pre-training the machine learning model to generate positions of a third in-game unit over time going from a starting point to an end point while avoiding a set of obstacles.

5. The method of claim 4, wherein pre-training comprises:
generating synthetic data comprising a plurality of routes, wherein each route comprises positions of a fourth in-game unit over time, going from one starting point of one or more starting points to one end point of one or more end points while avoiding one set of obstacles of one or more sets of obstacles; and
using the synthetic data to pre-train the machine learning model.

6. The method of claim 5, wherein generating the synthetic data comprises:
providing a first route from a first starting point to a first end point and avoiding a first set of obstacles; and
generating a second route that avoids the first set of obstacles by moving one of the positions in the first route to a new position and using a kinematic model to generate the second route so that the second route comprises the new position.

7. The method of claim 6, wherein generating the second route comprises moving the one position in predetermined spatial intervals to cover one quadrant of a two-dimensional space.

8. The method of claim 1, comprising:
generating a plurality of game lines in the second computer game from a single game line in the second computer game, wherein the single game line comprises generated positions and properties of one in-game unit over time in the second computer game, by requesting the machine learning model to generate alternative game line going from a first position in the game line to a second position in the game line.

9. The method of claim 1, wherein the machine learning model is one of a large language model (LLM) and a transformer type model.

10. The method of claim 1, wherein the positions and properties of the plurality of first in-game units over time in the first computer game are generated from at least one of log files of the first computer game, user input recordings, or gameplay footage of the first computer game.

11. The method of claim 1, wherein the positions and properties of a plurality of the first in-game units over time in the first computer game are provided to the machine learning model in the form of a graph using a game descriptive language.

12. The method of claim 1, wherein analyzing the positions of the plurality of the second in-game units over time in the second computer game to generate the second computerized restrictive environment for the second computer game comprises:
defining areas that include the positions as traversable areas, and the areas that do not include the positions as non-traversable areas.

13. A method for generating a second computer game, the method comprising, using a processor:
pre-training machine learning model to generate a route, wherein the route comprises positions of an in-game unit over time going from a starting point to an end point while avoiding obstacles;
training the machine learning model by providing game lines in a first computer game to the machine learning model to provide at least one game line of the second computer game;
analyzing the least one least one game line of the second computer game to generate a computerized restrictive environment and to disperse in-game units in the second computer game; and
providing the second computer game to a user using at least one input and output devices of a computer.

14. A system for generating a second computer game, the system comprising:
a memory; and
a processor to:
train a machine learning model to generate positions and properties of second in-game units over time in the second computer game, by providing the machine learning model data descriptive of positions and properties of a plurality of first in-game units over time in a first computer game; and
generate the second computer game by deriving a computerized restrictive environment and dispersing the second in-game units in the second computer game based on the generated positions and properties of the second in-game units over time in the second computer game.

15. The system of claim 14, comprising at least one input and output devices of a computer for providing the second computer game to a user.

16. The system of claim 14, comprising generating graphics for the derived computerized restrictive environment of a requested genre using a generative network.

17. The system of claim 14, wherein the processor is configured to pre-train the machine learning model to generate positions of a third in-game unit over time going from a starting point to an end point while avoiding a set of obstacles by:
generating synthetic data comprising a plurality of routes, wherein each route comprises positions of a fourth in-game unit over time, going from one starting point of one or more starting points to one end point of one or more end points while avoiding one set of obstacles of one or more sets of obstacles; and
using the synthetic data to pre-train the machine learning model.

18. The system of claim 17, wherein the processor is configured to generate the synthetic data by:
providing a first route from a first starting point to a first end point and avoiding a first set of obstacles; and
generating a second route that avoids the first set of obstacles by moving one of the positions in the first route to a new position and using a kinematic model to generate the second route so that the second route comprises the new position.

19. The system of claim 14, comprising:
generating a plurality of game lines in the second computer game from a single game line in the second computer game, wherein the single game line comprises generated positions and properties of one in-game unit over time in the second computer game, by requesting the machine learning model to generate alternative positions over time going from a first position in the game line to a second position in the game line.

20. The system of claim 14, wherein the machine learning model is one of a large language model (LLM) and a transformer type model.

21. The system of claim 14, wherein the positions and properties of the plurality of first in-game units over time in the first computer game are generated from at least one of log files of the first computer game, user input recordings, or gameplay footage of the first computer game.

22. The system of claim 14, wherein the positions and properties of a plurality of the first in-game units over time in the first computer game are provided to the machine learning model in the form of a graph using a game descriptive language.

23. The system of claim 14, wherein analyzing the positions of the plurality of the second in-game units over time in the second computer game to generate the second computerized restrictive environment for the second computer game comprises:
defining areas that include the positions as traversable areas, and the areas that do not include the positions as non-traversable areas.
